(19) United States
(12) Patent Application Publication
(10) Pub. No.: US 2005/0114134 A1
(43) Pub. Date: May 26, 2005

(54) Method and apparatus for continuous valued vocal tract resonance tracking using piecewise linear approximations

(75) Inventors: Li Deng, Sammamish, WA (US); Hagai Attias, San Francisco, CA (US); Alejandro Acero, Bellevue, WA (US); Leo Lee, Waterloo (CA)

Correspondence Address: Theodore M. Magee;Westman, Champlin & Kelly, Suite 1600, 900 Second Avenue South, Minneapolis, MN, 55402-3319, US

(73) Assignee: Microsoft Corporation, Redmond, WA (US)

(21) Appl. No.: 10/723,995

(22) Filed: Nov. 26, 2003

(51) Int. Cl. G10L 15/28; G10L 19/06

(52) U.S. Cl. 704/255; 704/209

(57) ABSTRACT

A method and apparatus tracks vocal tract resonance components, including both frequencies and bandwidths, in a speech signal. The components are tracked by defining a state equation that is linear with respect to a past vocal tract resonance vector and that predicts a current vocal tract resonance vector. An observation equation is also defined that is linear with respect to a current vocal tract resonance vector and that predicts at least one component of an observation vector. The state equation, the observation equation, and a sequence of observation vectors are used to identify a sequence of vocal tract resonance vectors using Kalman filter algorithm. Under one embodiment, the observation equation is defined based on a piecewise linear approximation to a non-linear function. The parameters of the linear approximation are selected based on pre-defined regions, which are determined from a crude estimate of a vocal tract resonance vector.

### BACKGROUND OF THE INVENTION

The present invention relates to speech recognition systems and in particular to speech recognition systems that exploit vocal tract resonances in speech.

In human speech, a great deal of information is contained in the first three or four resonant frequencies of the speech signal. In particular, when a speaker is pronouncing a vowel, the frequencies (and to a less extent, bandwidths) of these resonances indicate which vowel is being spoken.

Such resonant frequencies and bandwidths are often referred to collectively as formants. During sonorant speech, which is typically voiced, formants can be found as spectral prominences in a frequency representation of the speech signal. However, during non-sonorant speech, the formants cannot be found directly as spectral prominences. Because of this, the term “formants” has sometimes been interpreted as only applying to sonorant portions of speech. To avoid confusion, some researchers use the phrase “vocal tract resonance” to refer to formants that occur during both sonorant and non-sonorant speech. In both cases, the resonance is related to only the oral tract portion of the vocal tract.

To detect formants, systems of the prior art analyzed the spectral content of a frame of the speech signal. Since a formant can be at any frequency, the prior art has attempted to limit the search space before identifying a most likely formant value. Under some systems of the prior art, the search space of possible formants is reduced by identifying peaks in the spectral content of the frame. Typically, this is done by using linear predictive coding (LPC) which attempts to find a polynomial that represents the spectral content of a frame of the speech signal. Each of the roots of this polynomial represents a possible resonant frequency in the signal and thus a possible formant. Thus, using LPC, the search space is reduced to those frequencies that form roots of the LPC polynomial.

In other formant tracking systems of the prior art, the search space is reduced by comparing the spectral content of the frame to a set of spectral templates in which formants have been identified by an expert. The closest “n” templates are then selected and used to calculate the formants for the frame. Thus, these systems reduce the search space to those formants associated with the closest templates.

One system of the prior art, developed by the same inventors as the present invention, used a consistent search space that was the same for each frame of an input signal. Each set of formants in the search space was mapped into a feature vector. Each of the feature vectors was then applied to a model to determine which set of formants was most likely.

This system works well but is computationally expensive because it typically utilizes Mel-Frequency Cepstral Coefficient frequency vectors, which require the application of a set of frequencies to a complex filter that is based on all of the formants in the set of formants that is being mapped followed by a windowing step and a discrete cosine transform step in order to map the formants into the feature vectors. This computation was too time-consuming to be performed at run time and thus all of the sets of formants had to be mapped before run time and the mapped feature vectors had to be stored in a large table. This is less than ideal because it requires a substantial amount of memory to store all of the mapped feature vectors.

In another system developed by the present inventors, a set of discrete vocal tract resonance vectors are stored in a codebook. Each of the discrete vectors is converted into a simulated feature vector that is compared to an input feature vector to determine which discrete vector best represents an input speech signal. This system is less than ideal because it does not determine continuous values for the vocal tract resonance vectors but instead selects one of the discrete vocal tract resonance codewords.

### SUMMARY OF THE INVENTION

A method and apparatus tracks vocal tract resonance components in a speech signal. The components are tracked by defining a state equation that is linear with respect to a past vocal tract resonance vector and that predicts a current vocal tract resonance vector. An observation equation is also defined that is linear with respect to a current vocal tract resonance vector and that predicts at least one component of an observation vector. The state equation, the observation equation, and a sequence of observation vectors are used to identify a sequence of vocal tract resonance vectors. Under one embodiment, the observation equation is defined based on a linear approximation to a non-linear function. The parameters of the linear approximation are selected based on an estimate of a vocal tract resonance vector.

### BRIEF DESCRIPTION OF THE DRAWINGS

FIG. 1 is a block diagram of a general computing environment in which embodiments of the present invention may be practiced.

FIG. 2 is a graph of the magnitude spectrum of a speech signal.

FIG. 3 is a diagram showing a piecewise linear approximation to an exponential function.

FIG. 4 is a diagram showing a piecewise linear approximation to a sinusoidal function.

FIG. 5 is a flow diagram of a method under the present invention.

FIG. 6 is a block diagram of a training system for training a residual model.

FIG. 7 is a block diagram of a formant tracking system under one embodiment of the present invention.

### DETAILED DESCRIPTION OF ILLUSTRATIVE EMBODIMENTS

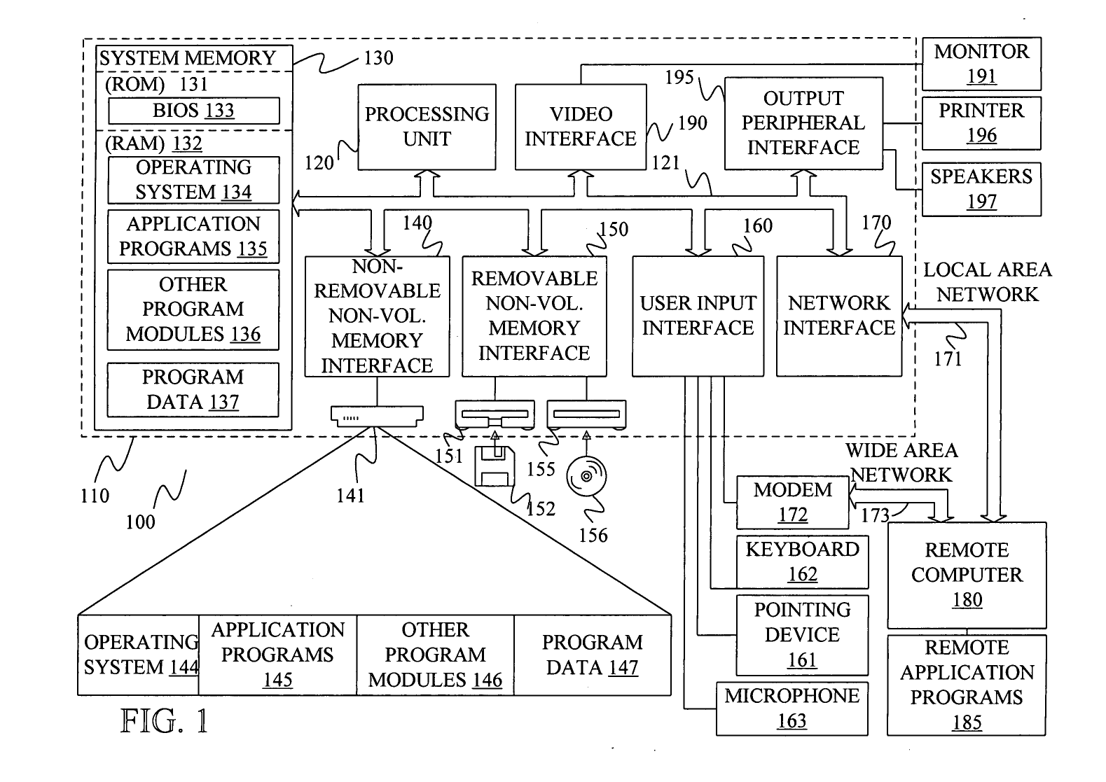

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

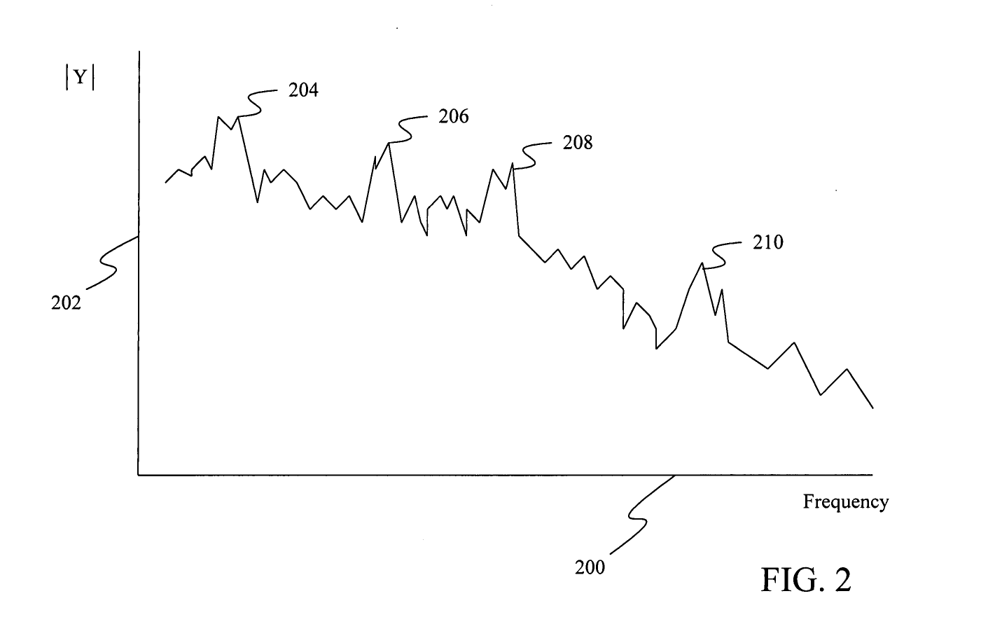

FIG. 2 is a graph of the frequency spectrum of a section of human speech. In FIG. 2, frequency is shown along horizontal axis 200 and the magnitude of the frequency components is shown along vertical axis 202. The graph of FIG. 2 shows that sonorant human speech contains resonances or formants, such as first formant 204, second formant 206, third formant 208, and fourth formant 210. Each formant is described by its center frequency, F, and its bandwidth, B.

The present invention provides methods for identifying the formant frequencies and bandwidths in a speech signal across a continuous range of formant frequencies and bandwidths, both in sonorant and non-sonorant speech. Thus, the invention is able to track vocal tract resonance frequencies and bandwidths.

To do this, the present invention models the hidden vocal tract resonance frequencies and bandwidths as a sequence of hidden states that each produces an observation. In one particular embodiment, the hidden vocal tract resonance frequencies and bandwidths are modeled using a state equation of:
xₜ=Φxₜ₋₁+(I−Φ)T+wₜ EQ. 1
and an observation equation of:
oₜ=C(xₜ)+vₜ EQ. 2
where xₜ is a hidden vocal tract resonance vector at time t consisting of xₜ={f₁,b₁,f₂,b₂,f₃,b₃,f₄,b₄}, xₜ₋₁ is a hidden vocal tract resonance vector at a previous time t−1, Φ is a system matrix, I is the identity matrix, T is a target vector for the vocal tract resonance frequencies and bandwidths, wₜ is noise in the state equation, oₜ is an observed vector, C(xₜ) is a mapping function from the hidden vocal tract resonance vector to an observation vector, and vₜ is the noise in the observation. Under one embodiment, Φ is a diagonal matrix with each entry having a value between 0.7 and 0.9 that has been empirically determined, and T is a vector, which, in one embodiment, has a value of:
(500 1500 2500 3500 200 300 400 400)^{T}
   Under this embodiment, the noise parameters wₜ and vₜ have values determined by random Gaussian samples with a zero mean vector and with diagonal covariance matrices. The diagonal elements of these matrices in this embodiment have values between 10 and 30,000 for wt, and values between 0.8 and 78 for vt.

Under one embodiment, the observed vector is a Linear Predictive Coding-Cepstra (LPC-cepstra) vector where each component of the vector represents an LPC order. As a result, the mapping function C(xₜ) can be determined precisely by an analytical nonlinear function. The nth component of the vector-valued function C(xₜ) for frame t is:

$${C}_{n} ( {x}_{i} ) = {\sum }_{k = 1}^{K} \frac{2}{n} {ⅇ}^{- π n \frac{{b}_{k} ( t )}{{f}_{2}}} cos ( 2 π n \frac{{f}_{k} ( t )}{{f}_{s}} ) \qquad EQ . 3$$

where Cₙ(xₜ) is the nth element in an Nth order LPC-Cepstrum feature vector, K is the number of vocal tract resonance (VTR) frequencies, fₖ(t) is the kth VTR frequency for frame t, bₖ(t) is the kth VTR bandwidth for frame t, and fₛ is the sampling frequency, which in many embodiments is 8 kHz and in other embodiments is 16 kHz. The C₀ element is set equal to logG, where G is a gain.

To identify a sequence of hidden vocal tract resonance vectors from a sequence of observation vectors, the present invention uses a Kalman filter. A Kalman filter provides a recursive technique that can determine a best estimate of the continuous-valued hidden vocal tract resonance vectors in the linear dynamic system represented by Equations 1 and 2. Such Kalman filters are well known in the art.

The Kalman filter requires that the right-hand side of Equations 1 and 2 be linear with respect to the hidden vocal tract resonance vector. However, the mapping function of Equation 3 is non-linear with respect to the vocal tract resonance vector. To address this, the present invention uses piecewise linear approximations in place of the exponent and cosine terms in Equation 3. Under one embodiment, the exponent term is represented by five linear regions and the cosine term is represented by ten linear regions.

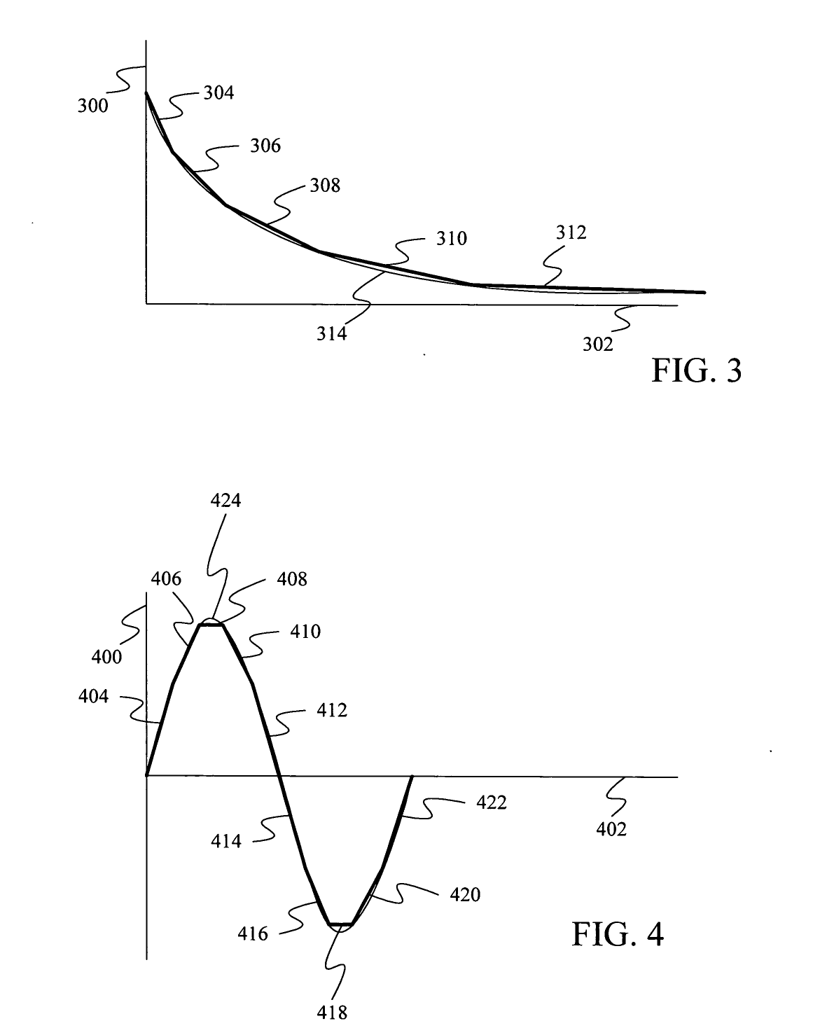

FIG. 3 shows an example of a piecewise linear approximation to the exponent term in Equation 3. The value of the exponent is shown along vertical axis 300 and the value of bandwidth bₖ for the kth VTR bandwidth is shown along horizontal axis 302. In FIG. 3, five linear segments 304, 306, 308, 310 and 312 are used to approximate exponent graph 314. The following table provides ranges of exponent values that each of the linear segments cover.

TABLE 1

| Linear Segment | Range Of Exponent Values |
|---|---|
| 304 | 0-100 Hz |
| 306 | 100-200 Hz |
| 308 | 200-300 Hz |
| 310 | 300-400 Hz |
| 312 | 400-500 Hz |

FIG. 4 shows an example of a piecewise linear approximation to the cosine term in Equation 3. The value of the cosine function is shown along vertical axis 400 and the value of frequency fₖ for the kth VTR frequency is shown along horizontal axis 402. In FIG. 4, a single cycle of the cosine function is shown, however, those skilled in the art will recognize that the same piecewise linear approximations can be used for each cycle of the cosine function. Under the embodiment of FIG. 4, the cosine function 424 is approximated by ten linear segments 404, 406, 408, 410, 412, 414, 416, 418, 420 and 422. Table 2 below provides the non-uniform range of cosine values covered by each linear segment, assuming that the full cycle covers the frequency range from 0 Hz to 8000 Hz.

TABLE 2

| Linear Segment | Range of Cosine Values |
|---|---|
| 404 | 0-500 Hz |
| 406 | 500-1000 Hz |
| 408 | 1000-3000 Hz |
| 410 | 3000-3500 Hz |
| 412 | 3500-4000 Hz |
| 414 | 4000-4500 Hz |
| 416 | 4500-5000 Hz |
| 418 | 5000-7000 Hz |
| 420 | 7000-7500 Hz |
| 422 | 7500-8000 Hz |

Using these linear approximations, Equation 3 is rewritten as:

$${C}_{n} ( {x}_{t} ) = {\sum }_{k = 1}^{K} \frac{2}{n} ( {α}_{kx} {x}_{t} + {β}_{kx} ) ( {γ}_{kx} {x}_{t} + {δ}_{kx} ) \qquad EQ . 4$$

where αₖₓ is the slope and βₖₓ is the intercept of the linear segment that approximates the exponent term and γₖₓ is the slope and δₖₓ is the intercept of the linear segment that approximates the cosine term. Note that all four terms are dependent on xₜ because the linear segments that are used to approximate the non-linear functions are selected based on the region determined by the value of xₜ according to Tables 1 and 2.

The form of the mapping function in Equation 4 is still not linear in xₜ because of the quadratic term. Under one embodiment of the present invention, the incremental portion of this term is ignored, resulting in a linear equation from xₜ to Cₙ(xₜ).

In this form, as long as the parameters are fixed based on the regions of the segment exemplified in Tables 1 and 2, a Kalman Filter is applied directly to obtain the sequence of continuous valued states x_{1:T} from a sequence of observed LPC feature vectors o_{1:T.}

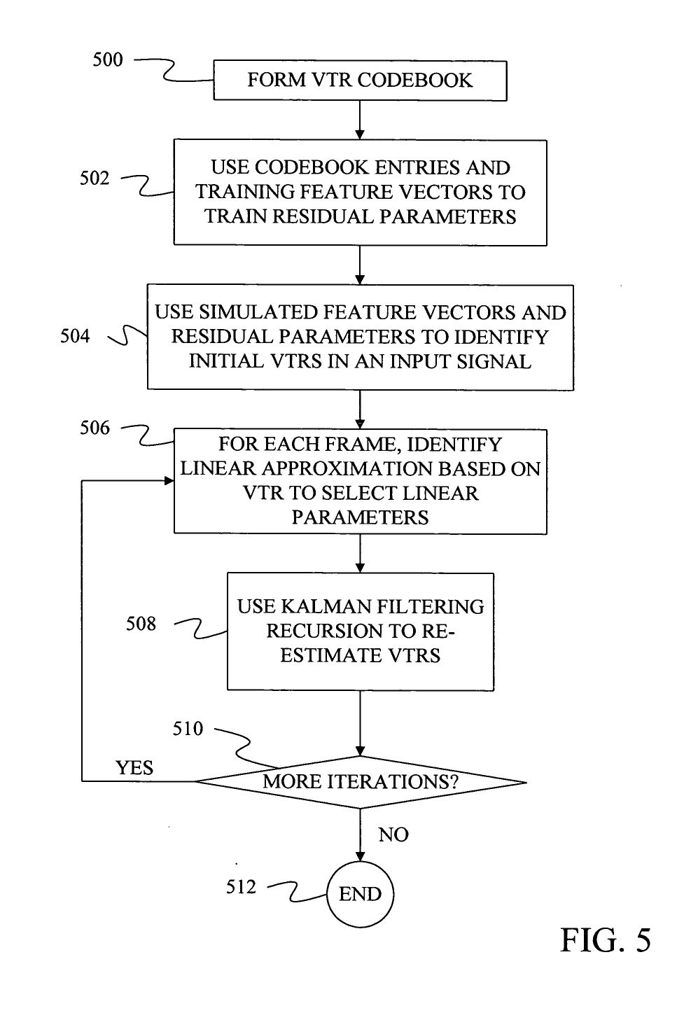

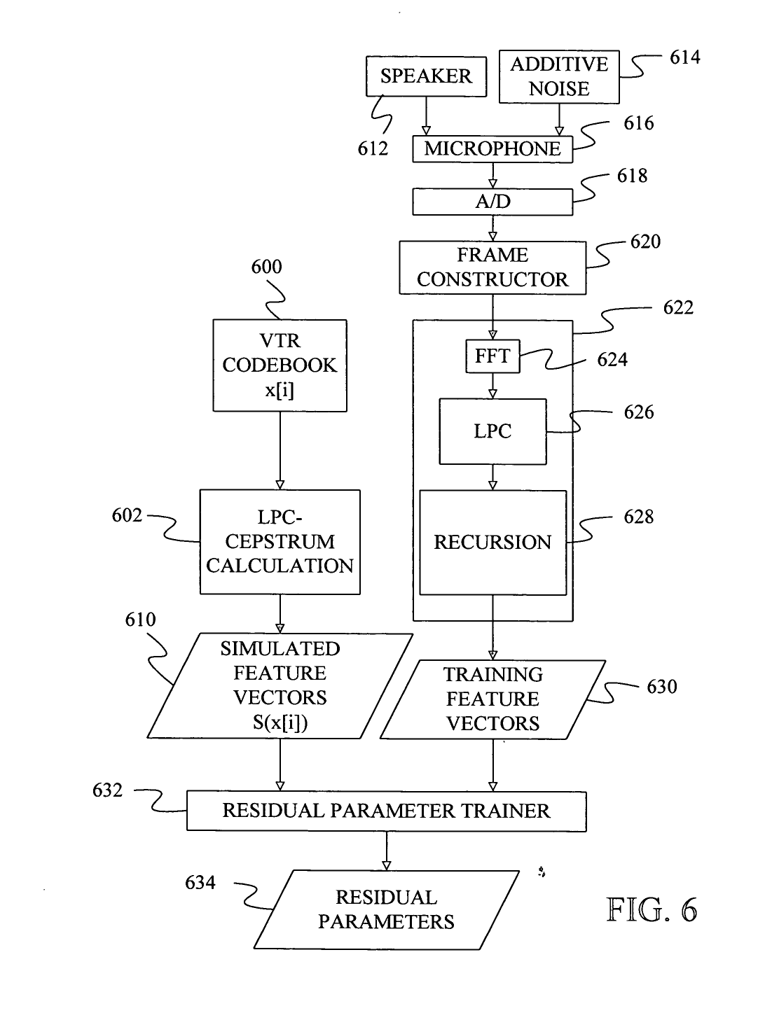

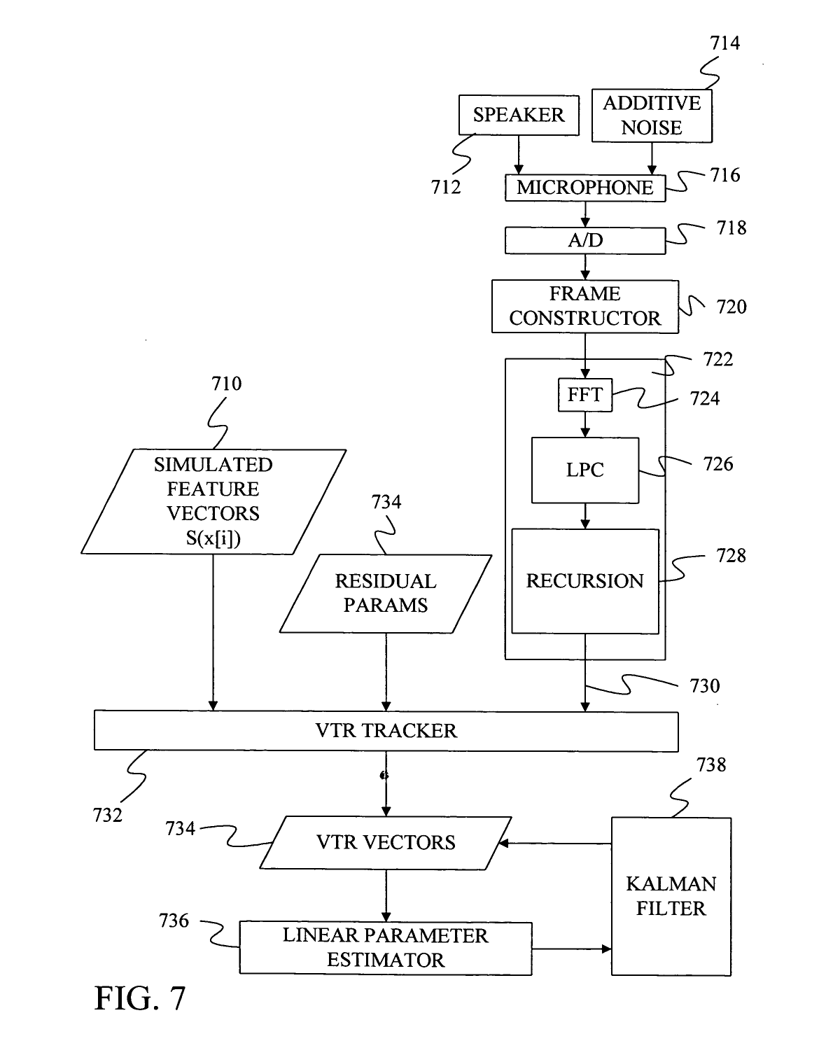

FIG. 5 provides a general flow diagram of a method of selecting linear approximations and using the approximation in a Kalman Filter to identify a sequence of continuous valued states using Equations 1, 2 and 4 while ignoring the incremental portion of the quadratic term in Equation 4. FIGS. 6 and 7 provide block diagrams of components used in the method of FIG. 5.

In step 500 of FIG. 5, a vocal tract resonance (VTR) codebook, stored in a table, is constructed by quantizing the possible VTR frequencies and bandwidths to form a set of quantized values and then forming entries for different combinations of the quantized values. Thus, the resulting codebook contains entries that are vectors of VTR frequencies and bandwidths. For example, if the codebook contains entries for four VTRs, the ith entry x[i] in the codebook would be a vector of [F₁ᵢ, B₁ᵢ, F₂ᵢ, B₂ᵢ, F₃ᵢ, B₃ᵢ, F₄ᵢ, B₄ᵢ] where F₁ᵢ, F₂ᵢ, F₃ᵢ, and F₄ᵢ are the frequencies of the first, second, third and fourth VTRs and B₁ᵢ, B₂ᵢ, B₃ᵢ, and B₄ᵢ are the bandwidths for the first, second, third and fourth VTRs. In the discussion below, the index to the codebook, i, is used interchangeably with the value stored at that index, x[i]. When the index is used alone below, it is intended to represent the value stored at that index.

Under one embodiment, the formants and bandwidths are quantized according to the entries in Table 3 below, where Min(Hz) is the minimum value for the frequency or bandwidth in Hertz, Max(Hz) is the maximum value in Hertz, and “Num. Quant.” is the number of quantization states. For the frequencies and the bandwidths, the range between the minimum and maximum is divided by the number of quantization states to provide the separation between each of the quantization states. For example, for bandwidth B₁ in Table 3, the range of 260 Hz is evenly divided by the 5 quantization states such that each state is separated from the other states by 65 Hz. (i.e., 40, 105, 170, 235, 300).

TABLE 3

| | Min (Hz) | Max (Hz) | Num. Quant. |
|---|---|---|---|
| F₁ | 200 | 900 | 20 |
| F₂ | 600 | 2800 | 20 |
| F₃ | 1400 | 3800 | 20 |
| F₄ | 1700 | 5000 | 20 |
| B₁ | 40 | 300 | 5 |
| B₂ | 60 | 300 | 5 |
| B₃ | 60 | 500 | 5 |
| B₄ | 100 | 700 | 5 |

The number of quantization states in Table 3 could yield a total of more than 100 million different sets of VTRs. However, because of the constraint F₁<F₂<F₃<F₄ there are substantially fewer sets of VTRs in the codebook.

After the codebook has been formed, the entries in the codebook are used to train parameters that describe a residual random variable at step 502. The residual random variable is the difference between a set of observation training feature vectors and a set of simulated feature vectors. In terms of an equation:
νₜ=oₜ−S(xₜ[i]) EQ. 5
where νₜ is the residual, oₜ is the observed training feature vector at time t and S(xₜ[i]) is a simulated feature vector.

As shown in FIG. 6, the simulated feature vectors S(xₜ[i]) 610 are constructed when needed by applying a set of VTRs xₜ[i] in VTR codebook 600 to an LPC-Cepstrum calculator 602, which performs the following calculation:

$${S}_{n} ( {x}_{t} [ i ] ) = {\sum }_{k = 1}^{K} \frac{2}{n} {ⅇ}^{- π n \frac{{b}_{k} [ i ]}{{f}_{s}}} cos ( 2 π n \frac{{f}_{k} [ i ]}{{f}_{s}} ) \qquad EQ . 6$$

where Sₙ(xₜ[i]) is the nth element in an nth order LPC-Cepstrum feature vector, K is the number of VTRs, fₖ is the kth VTR frequency, bₖ is the kth VTR bandwidth, and fₛ is the sampling frequency, which in many embodiments is 8 kHz. The S₀ element is set equal to logG, where G is a gain.

To produce the observed training feature vectors oₜ used to train the residual model, a human speaker 612 generates an acoustic signal that is detected by a microphone 616, which also detects additive noise 614. Microphone 616 converts the acoustic signals into an analog electrical signal that is provided to an analog-to-digital (A/D) converter 618. The analog signal is sampled by A/D converter 618 at the sampling frequency fₛ and the resulting samples are converted into digital values. In one embodiment, A/D converter 618 samples the analog signal at 8 kHz with 16 bits per sample, thereby creating 16 kilobytes of speech data per second. In other embodiments, A/D converter 68 samples the analog signal at 16 kHz. The digital samples are provided to a frame constructor 620, which groups the samples into frames. Under one embodiment, frame constructor 620 creates a new frame every 10 milliseconds that includes 25 milliseconds worth of data.

The frames of data are provided to an LPC-Cepstrum feature extractor 622, which converts the signal to the frequency domain using a Fast Fourier Transform (FFT) 624 and then identifies a polynomial that represents the spectral content of a frame of the speech signal using an LPC coefficient system 626. The LPC coefficients are converted into LPC cepstrum coefficients using a recursion 628. The output of the recursion is a set of training feature vectors 630 representing the training speech signal.

The simulated feature vectors 610 and the training feature vectors 630 are provided to residual trainer 632 which trains the parameters for the residual νₜ.

Under one embodiment, νₜ is a single Gaussian with mean h and a precision D, where h is a vector with a separate mean for each component of the feature vector and D is a diagonal precision matrix with a separate value for each component of the feature vector.

These parameters are trained using an Expectation-Maximization (EM) algorithm under one embodiment of the present invention. During the E-step of this algorithm, a posterior probability γₜ(i)=p(xₜ[i]|o₁^{N}) is determined. Under one embodiment, this posterior is determined using a backward-forward recursion defined as:

$${γ}_{t} ( i ) = \frac{{ρ}_{t} ( i ) {σ}_{t} ( i )}{{\sum }_{i} {ρ}_{t} ( i ) {σ}_{t} ( i )} \qquad EQ . 7$$

where ρₜ(i) and σₜ(i) are recursively determined as:

$$\begin{matrix}{ρ}_{t} ( i ) = {\sum }_{j} {ρ}_{t - 1} ( j ) p ( {x}_{t} [ i ] \vert {x}_{t - 1} [ j ] ) p ( {o}_{t} \vert {x}_{t} [ i ] = x [ i ] ) & EQ . 8 \\ {σ}_{t} ( i ) = {\sum }_{j} {σ}_{t + 1} ( j ) p ( {x}_{t} [ i ] \vert {x}_{t + 1} [ j ] ) p ( {o}_{t} \vert {x}_{t} [ i ] = x [ i ] ) & EQ . 9\end{matrix}$$

Under one aspect of the invention, the transition probabilities p(xₜ[i]|xₜ₋₁[j]) and p(xₜ[i]|xₜ₊₁[j]) are determined using Equation 1 above, which is repeated here for convenience using the codebook index notation:
xₜ[i]=Φxₜ₋₁[i]+(I−Φ)T+wₜ EQ. 10
where xₜ[i] is the value of the VTRs at frame t, xₜ₋₁[j] is the value of the VTRs at previous frame t−1, Φ is a rate, T is a target for the VTRs associated with frame t and wₜ is the noise at frame t, which in one embodiment is assumed to be a zero-mean Gaussian with a precision matrix B.

Using this dynamic model, the transition probabilities can be described as Gaussian functions:
p(xₜ[i]|xₜ₋₁[j])=N(xₜ[i];Φxₜ₋₁[i]+(I−Φ)T,B) EQ. 11
p(xₜ[i]|xₜ₊₁|[j])=N(xₜ₊₁[i]; Φxₜ[i]+(I−Φ)T,B) EQ. 12

Alternatively, the posterior probability γₜ(i)=p(xₜ[i]|o₁^{N}) may be estimated by making the probability only dependent on the current observation vector and not the sequence of vectors such that the posterior probability becomes:
γₜ(i)≈p(xₜ[i]|oₜ) EQ. 13
which can be calculated as:

$$p ( {x}_{t} [ i ] \vert {o}_{t} ) = \frac{N ( {o}_{t} ; S ( {x}_{t} [ i ] ) + \hat{h} , \hat{D} )}{{\sum }_{i - 1}^{I} N ( {o}_{t} ; S ( {x}_{t} [ i ] ) + \hat{h} , \hat{D} )} \qquad EQ . 14$$

where ĥ is the mean of the residual and \hat{D} is the precision of the residual as determined from a previous iteration of the EM algorithm or as initially set if this is the first iteration.

After the E-step is performed to identify the posterior probability γₜ(i)=p(xₜ[i]|o₁^{N}), an M-step is performed to determine the mean h and each diagonal element d⁻¹ of the variance D⁻¹ (the inverse of the precision matrix) of the residual using:

$$\begin{matrix}\hat{h} = \frac{{\sum }_{t = 1}^{N} {\sum }_{i - 1}^{I} {γ}_{t} ( i ) \{ {o}_{t} - S ( {x}_{t} [ i ] ) \}}{N} & EQ . 15 \\ {\hat{d}}^{- 1} = \frac{{\sum }_{t = 1}^{N} {\sum }_{i - 1}^{I} {γ}_{t} ( i ) {\{ {o}_{t} - S ( {x}_{t} [ i ] ) - \hat{h} \}}^{2}}{N} & EQ . 16\end{matrix}$$

where N is the number of frames in the training utterance, I is the number of quantization combinations for the VTRs, oₜ is the observed feature vector at time t and S(xₜ[i]) is a simulated feature vector for VTRs xₜ[i].

Residual trainer 632 updates the mean and variance multiple times by iterating the E-step and the M-step, each time using the mean and variance from the previous iteration. After the mean and variance reach stable values, they are stored as residual parameters 634.

Once residual parameters 634 have been constructed they can be used in step 504 of FIG. 5 to identify VTR vectors in an input speech signal. A block diagram of a system for identifying VTR vectors is shown in FIG. 7.

In FIG. 7, a speech signal is generated by a speaker 712. The speech signal and additive noise 714 are converted into a stream of feature vectors 730 by a microphone 716, A/D converter 718, frame constructor 720, and feature extractor 722, which consists of an FFT 724, LPC system 726, and a recursion 728. Note that microphone 716, A/D converter 718, frame constructor 720 and feature extractor 722 operate in a similar manner to microphone 616, A/D converter 618, frame constructor 620 and feature extractor 622 of FIG. 6.

The stream of feature vectors 730 is provided to a VTR tracker 732 together with residual parameters 634 and simulated feature vectors 610. VTR tracker 732 uses dynamic programming to identify a sequence of most likely VTR vectors 734. In particular, it utilizes a Viterbi decoding algorithm where each node in the trellis diagram has an optimal partial score of:

$$\begin{matrix}{δ}_{t} ( i ) = {max}_{{x [ i ]}_{1}^{t - 1}} {\prod }_{τ = 1}^{t - 1} p ( {o}_{τ} \vert {x}_{τ} [ i ] ) p ( {o}_{τ} \vert {x}_{τ} [ i ] = x [ i ] ) \times & EQ . 17 \\ p ( {x [ i ]}_{1} ) {\prod }_{τ = 2}^{t - 1} p ( {x}_{τ} [ i ] \vert {x}_{τ - 1} [ i ] ) p ( {x}_{τ} [ i ] & \\ = x [ i ] \vert {x}_{t - 1} [ i ] ) & \end{matrix}$$

Based on the optimality principle, the optimal partial likelihood at the processing stage of t+1 can be computed using the following Viterbi recursion:

$$\begin{matrix}{δ}_{t + 1} ( i ) = {max}_{{i}^{′}} {δ}_{t} ( {i}^{′} ) p ( {x}_{t + 1} [ i ] & EQ . 18 \\ = x [ i ] \vert {x}_{t} [ i ] & \\ = x [ {i}^{′} ] ) p ( {o}_{t + 1} \vert {x}_{t + 1} [ i ] & \\ = x [ i ] ) & \end{matrix}$$

In Equation 18, the “transition” probability p(xₜ₊₁[i]=x[i]|xₜ[i]=x[i′]) is calculated using state Equation 10 above to produce a Gaussian distribution of:
p(xₜ₊₁[i]=x[i]|xₜ[i]=x[i′])=N(xₜ₊₁[i];Φxₜ[i′]+(I−Φ)T,B) EQ. 19
where Φxₜ[i]+(I−Φ)T is the mean of the distribution and B is the precision of the distribution.

The observation probability p(oₜ₊₁|xₜ₊₁[i]=x[i]) of Equation 18 is treated as a Gaussian and is computed from observation Equation 5 and the residual parameters h and D such that:
p(oₜ₊₁|xₜ₊₁[i]=x[i])=N(oₜ₊₁;S(xₜ₊₁[i])+h,D) EQ. 20
Back tracing of the optimal quantization index i′ in equation 20 provides the initial VTR sequence 734.

To reduce the number of computations that must be performed, a pruning beam search may be performed instead of a rigorous Viterbi search. In one embodiment, an extreme form of pruning is used where only one index is identified for each frame.

After initial VTR sequence 734 has been identified at step 504, the initial VTR sequence is provided to a linear parameter estimator 736, which selects the parameters for the linear approximations of Equation 4 above at step 506. Specifically, for each frame, the initial VTR vector for the frame is used to determine the values of the linear parameters αₖₓ, βₖₓ, γₖₓ, and δₖₓ for each vocal tract resonance index k and each LPC order n.

Under one embodiment, the values of linear parameters αₖₓ and βₖₓ are determined for an LPC order n by applying bandwidth bₖ of the initial VTR vector to the exponent term

$${ⅇ}^{- π n \frac{{b}_{k}}{{f}_{s}}}$$

and evaluating the exponent. The linear segment of FIG. 3 that spans that value of the exponent is then selected, thereby selecting the linear parameters αₖₓ and βₖₓ that define the linear segment. Note that each of these parameters is a vector that has a value of zero for every vector component except the vector component associated with bandwidth bₖ.

Under one embodiment, the values of linear parameters γₖₓ and δₖₓ are determined for an LPC order n by applying frequency fₖ of the initial VTR vector to the cosine term

$$cos ( 2 π n \frac{{f}_{k}}{{f}_{s}} )$$

and evaluating the cosine. The linear segment of FIG. 4 that spans that value of the cosine is then selected, thereby selecting the linear parameters γₖₓ and δₖₓ that define the linear segment. Note that each of these parameters is a vector that has a value of zero for every vector component except the vector component associated with frequency fₖ.

At step 508, the linear parameters for each frame are applied to Equation 4. Ignoring the incremental portion of the quadratic term in Equation 4, equation 4 is used in Equation 2. Equations 1 and 2 are then provided to a Kalman filter 738, which re-estimates the VTR vectors 734 for each frame. At step 510, the process determines if there are more iterations to be performed. If there are more iterations, the process returns to step 506, where the linear parameters are re-estimated from the new VTR vectors. The new linear parameters are then applied to Equation 2 through Equation 4 and Equations 1 and 2 are used in Kalman Filter 738 at step 508 to re-estimate the VTR vectors. Steps 506, 508 and 510 are iterated until a determination is made at step 510 that no further iterations are needed. At that point, the process ends at step 512 and the last estimation of VTR vectors 734 is used as the sequence of vocal tract resonance frequencies and bandwidths for the input signal.

Note that the Kalman Filter 738 provides continuous values for the vocal tract resonance vectors. Thus, the resulting sequence of vocal tract resonance frequencies and bandwidths is not limited to the discrete values found in VTR codebook 600.

Although the present invention has been described with reference to particular embodiments, workers skilled in the art will recognize that changes may be made in form and detail without departing from the spirit and scope of the invention.

1. A method of tracking vocal tract resonance frequency in a speech signal, the method comprising:
defining a state equation that is linear with respect to a past vocal tract resonance vector and that predicts a current vocal tract resonance vector;
defining an observation equation that is linear with respect to a current vocal tract resonance vector and that predicts at least one component of an observation vector; and
using the state equation, the observation equation, and a sequence of observation vectors to identify a sequence of vocal tract resonance vectors, each vocal tract resonance vector comprising at least one vocal tract resonance frequency.

2. The method of claim 1 wherein using the state equation, the observation equation, and the sequence of observation vectors to identify a sequence of vocal tract resonance vectors comprises applying the state equation, the observation equation and the sequence of observation vectors to a Kalman Filter.

3. The method of claim 1 wherein identifying a vocal tract resonance vector comprises identifying a vocal tract resonance vector from a continuous set of values.

4. The method of claim 1 wherein defining the observation equation comprises defining a linear approximation to a function that is non-linear with respect to the vocal tract resonance vector.

5. The method of claim 4 wherein defining the observation equation further comprises defining a linear approximation to the product of two functions that are each non-linear with respect to the vocal tract resonance vector.

6. The method of claim 5 wherein one of the functions that is non-linear with respect to the vocal tract resonance vector is an exponential function that is non-linear with respect to the bandwidth components of the vocal tract resonance vector.

7. The method of claim 5 wherein one of the functions that is non-linear with respect to the vocal tract resonance vector is a sinusoidal function that is non-linear with respect to the frequency components of the vocal tract resonance vector.

8. The method of claim 4 wherein defining a linear approximation comprises selecting a linear approximation from a set of linear approximations that together form a piecewise linear approximation to the non-linear function.

9. The method of claim 4 wherein defining a linear approximation comprises evaluating the non-linear function based on an estimate of a vocal tract resonance vector to produce a non-linear function value and using the non-linear function value to select parameters for the linear approximation.

10. The method of claim 9 wherein defining a linear approximation further comprises using the non-linear function value to select a linear approximation from a set of linear approximations that together form a piecewise linear approximation to the non-linear function.

11. The method of claim 1 further comprising:
using the identified vocal tract resonance vectors to redefine the observation equation; and
using the redefined observation equation, the state equation, and the observation vectors to identify a new sequence of vocal tract resonance vectors.

12. The method of claim 11 wherein redefining the observation equation comprises using an identified vocal tract resonance vector to select parameters for at least one linear approximation to a function that is non-linear with respect to a vocal tract resonance vector.

13. The method of claim 12 wherein using an identified vocal tract resonance vector to select parameters comprises evaluating the non-linear function using the vocal tract resonance vector to produce a non-linear function value and using the non-linear function value to select parameters for at least one linear approximation.

14. A computer-readable medium having computer-executable instructions for performing steps comprising:
using an estimate of at least one vocal tract resonance component to select a linear approximation to a function that is non-linear with respect to the vocal tract resonance component;
using the linear approximation to define an observation equation; and
using the observation equation and at least one observed vector to re-estimate the vocal tract resonance component.

15. The computer-readable medium of claim 14 wherein selecting a linear approximation comprises selecting one linear approximation from a set of linear approximations that form a piecewise linear approximation of the non-linear function.

16. The computer-readable medium of claim 14 wherein selecting a linear approximation comprises applying the vocal tract resonance component to the non-linear function to form a function value and selecting the linear approximation based on the function value.

17. The computer-readable medium of claim 14 wherein re-estimating the value of the vocal tract resonance component further comprises using a state equation that is linear with respect to the vocal tract resonance component.

18. The computer-readable medium of claim 17 wherein re-estimating the value of the vocal tract resonance component further comprises applying the state equation, the observation equation and the at least one observed vector to a Kalman Filter.

19. The computer-readable medium of claim 14 further comprising selecting a second linear approximation to a second function that is non-linear with respect to the vocal tract resonance component and using the second linear approximation to define the observation equation.

20. The computer-readable medium of claim 14 wherein the non-linear function comprises an exponential function.

21. The computer-readable medium of claim 14 wherein the non-linear function comprises a sinusoidal function.

22. The computer-readable medium of claim 14 wherein the vocal tract resonance component is continuous valued.
